(19) United States
(12) Patent Application Publication
(10) Pub. No.: US 2007/0002160 A1
(43) Pub. Date: Jan. 4, 2007

(54) Electronic camera

(75) Inventor: Takao Goto, Tokyo (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Tokyo (JP)

(21) Appl. No.: 11/475,047

(22) Filed: Jun. 27, 2006

(30) Foreign Application Priority Data
Jun. 30, 2005 (JP) JP 2005-192120

(51) Int. Cl. H04N 5/225

(52) U.S. Cl. 348/340

(57) ABSTRACT

An electronic camera includes a sensor substrate at which an imaging element is mounted; a main substrate on which an electrical component other than the imaging element is mounted, comprising an opening at which the sensor substrate is disposed; and a reception unit into which an electronic unit is detachably loaded, with the reception unit ranging astride the opening at the main substrate and fixed onto the main substrate so as to reinforce the main substrate.

### INCORPORATION BY REFERENCE

The disclosure of the following priority application is herein incorporated by reference: Japanese Patent Application No. 2005-192120 filed Jun. 30, 2005

### BACKGROUND OF THE INVENTION

1. Field of the Invention

The present invention relates to an electronic camera

2. Description of Related Art

The electronic camera disclosed in Japanese Laid Open Patent Publication No. 2002-320132 includes sensor substrate at which an imaging element is mounted and a main substrate at which other electric components are mounted, provided independently of each other and connected with each other via a flexible wiring member such as a flexible printed board. The imaging element and other electric components are mounted on separate substrates in the camera so as to ensure that any external force applied to the main substrate will not be transmitted to the imaging substrate where the imaging element which needs to sustain a very high level of positional accuracy is mounted. The structure described above is particularly effective when there is a likelihood of an external force being applied to the main substrate when a memory card, a wireless communication card or the like is being loaded into a card-slot of the camera.

However, if the main substrate and the imaging substrate are layered on top of the other, the thickness of the camera is bound to be significant.

### SUMMARY OF THE INVENTION

An electronic camera according to a first aspect of the present invention includes a sensor substrate at which an imaging element is mounted; a main substrate on which an electrical component other than the imaging element is mounted, comprising an opening at which the sensor substrate is disposed; and a reception unit into which an electronic unit is detachably loaded, with the reception unit ranging astride the opening at the main substrate and fixed onto the main substrate so as to reinforce the main substrate. The main substrate may includes an electrical contact point that makes contact with the electronic unit.

It is preferable that the reception unit receives the electronic unit formed in a plate shape. The reception unit may receive the electronic unit including a wireless communication unit. The reception unit may receive the electronic unit including a memory card in which image data are recorded. The reception unit may receive the electronic unit including a battery.

It is preferable that the electronic camera according to the first aspect further includes a lid member that opens and closes to cover an entrance to the reception unit, part of the wireless communication unit, which includes an antenna, projects out from a casing of the electronic camera when the wireless communication unit is loaded into the reception unit; and the lid member protects the part of the wireless communication unit that projects out from the casing. It is preferable that the part of the wireless communication unit projects out from a side surface of the casing; and the lid member covers an entire front surface or an entire rear surface of the antenna that projects out. A grip unit may be further provided which is disposed near a side surface present on a side opposite from the side surface from which the part of the wireless communication unit projects.

An electronic camera according to a second aspect of the present invention includes a reception unit at which a wireless communication unit is detachably loaded; a casing in which the reception unit is housed; an antenna that projects out of the casing when the wireless communication unit is loaded in reception unit; and a lid member that opens and closes to cover an entrance to the reception unit and protects part of the wireless communications unit projecting out of the casing, which includes the antenna.

In the electronic camera according to the second aspect, the casing may be a casing of the electronic camera; the part of the wireless communication unit may project out from a side surface of the casing of the electronic camera; and the lid member may cover an entire front surface or an entire rear surface of the part of the wireless communication unit that projects out. A grip unit may be further provided which is disposed near a side surface present on a side opposite from the side surface from which the part of the wireless communication unit projects.

In the electronic camera according to the first aspect, the lid member may open or close as the lid member rotates around an axis extending along a longer side of the entrance to the reception unit. It is preferable that the lid member enters an open state by rotating around the axis to protect the part of the wireless communication unit that projects out. A close lock member that locks the lid member in a closed state; and an open lock member that locks the lid member in the open state may be further provided.

### BRIEF DESCRIPTION OF THE DRAWINGS

FIG. 1 is a sectional view of a camera achieved in an embodiment of the present invention taken along the horizontal direction showing the camera without a wireless communication card loaded therein;

FIG. 2 is a sectional view taken along line II-II in FIG. 1;

FIG. 3 is a sectional view similar to FIG. 1, showing the camera with a wireless communication card loaded therein;

FIG. 4 is a front view of the camera in FIG. 3; and

FIG. 5 presents another example of an opening at which a sensor substrate may be disposed.

### DESCRIPTION OF PREFERRED EMBODIMENT

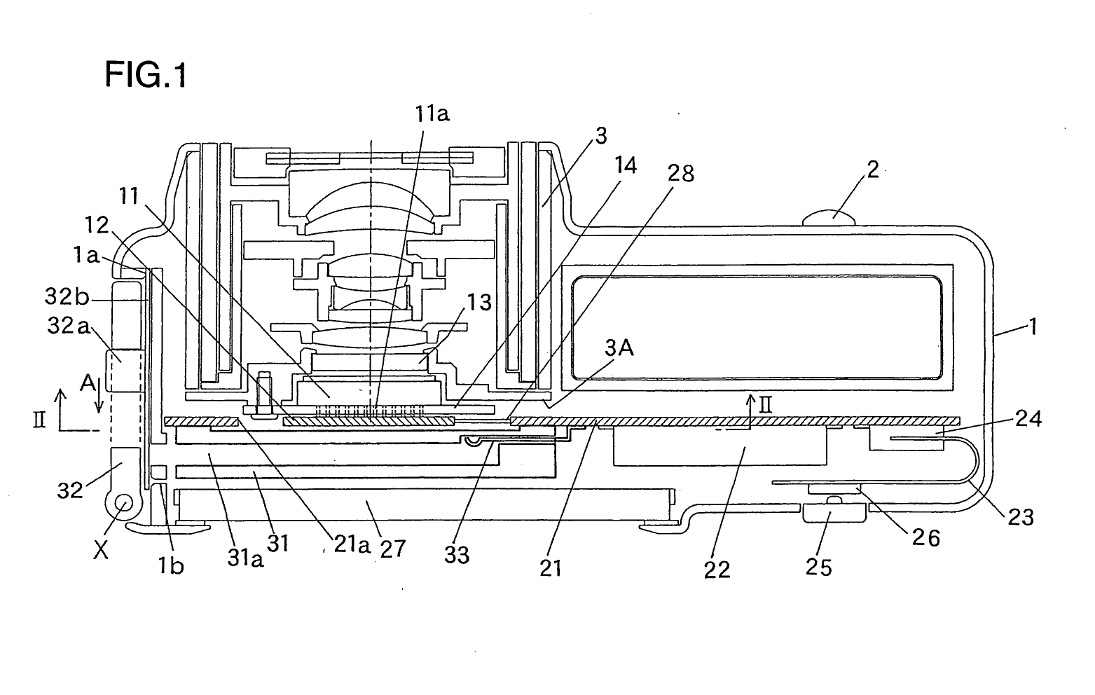

An embodiment of the present invention is now explained in reference to FIGS. 1 through 4.

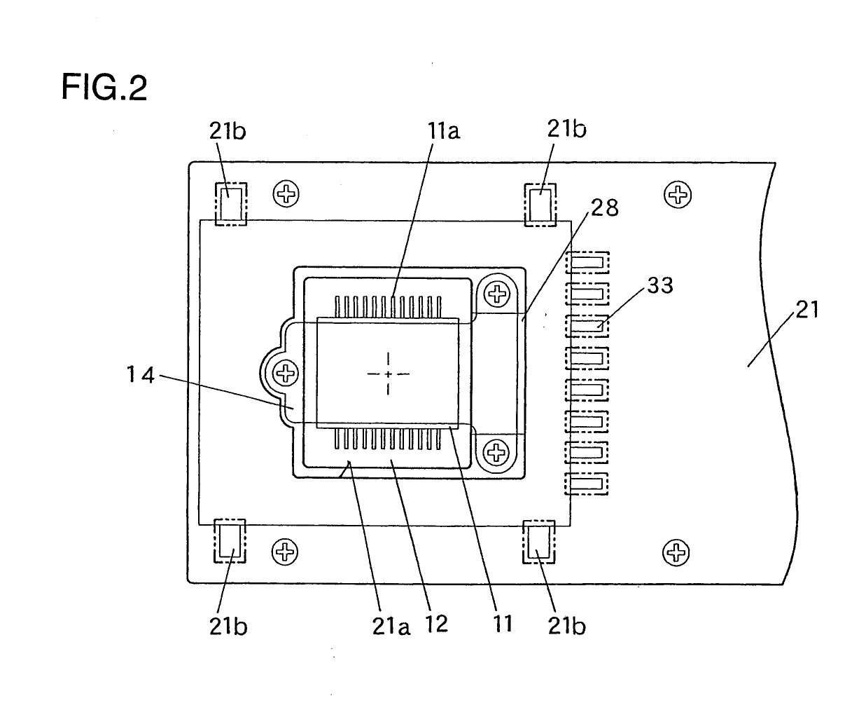

FIG. 1 is a sectional view of an electronic camera achieved in the embodiment, taken along the horizontal direction, and FIG. 2 is a sectional view taken along line II-II of FIG. 1. On the right side at the front surface of an external cover 1 constituting the outer frame of a camera body, a grip unit 2 is disposed. A photographic lens barrel 3 is disposed inside the cover 1, with an imaging unit disposed to the rear of the lens barrel 3.

The imaging unit includes an imaging element 11 constituted with a CCD, a CMOS or the like, a sensor substrate 12 at which the imaging element 11 is mounted, an optical filter 13 disposed to the front of the imaging element 11 and the like. The imaging element 11 is bonded onto a holding plate 14 so as to assure a high level of positional accuracy and, as the holding plate 14 is screwed onto a casing 3A of the lens barrel 3, the imaging element 11 and the filter 13 become fixed onto the lens barrel 3 as an integrated unit. As FIG. 2 clearly indicates, a lead 11a of the imaging element 11 extends astride the holding plate 14 and is connected to the imaging substrate 12. A light flux having been transmitted through lenses inside the lens barrel 3 is received at the imaging element 11 where it is converted to electrical image data. The image data then undergo various types of signal processing and are recorded into a recording medium as an image file.

To the rear of the imaging element 11, a main electrical substrate (main substrate) 21 is disposed. In addition to various electronic components mounted at the main substrate 21 to be engaged in camera operations such as an image memory 22 used as an image recording medium and a CPU, the main substrate 21 includes a connector 24 mounted thereat to connect with a flexible printed circuit board (hereafter referred to as an FPC) 23 for operation signal input. For instance, as an operation button 25 disposed at the rear surface of the camera is pressed down, an operation switch 26 enters an ON state and the ON signal from the operation switch 26 is transmitted to a control unit on the main substrate 21 via the FPC 23 and the connector 24. It is to be noted that an image, another type of information or the like can be displayed at the screen of a liquid crystal monitor 27 disposed at the camera rear surface.

As shown in FIG. 1, the imaging substrate 12 and the main substrate 21 are set on a substantially single plane ranging perpendicular to the photographic optical axis. Namely, an opening 21a assuming a rectangular shape shown in FIG. 2 is formed at the main substrate 21, and the imaging substrate 12 is disposed inside this opening 21a. The two substrates 12 and 21 are electrically connected with each other via a flexible printed circuit board (FPC) 28 so as to be able to exchange electrical signals with each other. By disposing the imaging substrate 12 and the main substrate 21 on a substantially single plane as described above rather than disposing them one on top of the other along the optical axis, the profile of the camera can be reduced. Since the FPC 28 is flexible, any positional misalignment occurring between the main substrate 21 and the imaging substrate 12 along the optical axis is absorbed at the FPC 28 and thus, no undesirable load is applied to the imaging substrate 12. In addition, any external force to which the main substrate 21 may be subjected to will not be transmitted to the imaging substrate 12.

However, the presence of the opening 21a formed at the main substrate 21 is likely to reduce the strength of the main substrate 21 around the opening 21a and the main substrate 21 may become deformed due to an external force or the like to result in a disconnection or the like. Accordingly, a card slot for wireless communication (hereafter referred to as a wireless communication slot) 31 is used to make up for the reduced strength of the main substrate 21.

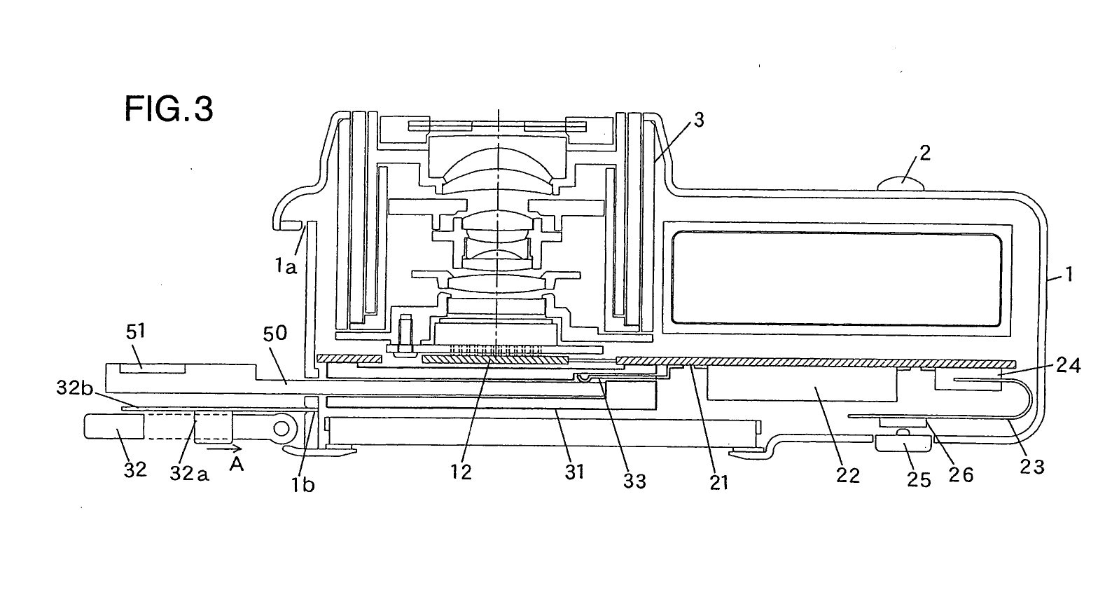

The wireless communication slot 31, constituted of a hard material achieving a certain level of strength, includes a card loading chamber 31a at which a wireless communication card 50 (see FIG. 3) is detachably loaded. The slot 31 is disposed in the space between the main substrate 21 and the liquid crystal monitor 27 so as to range astride the opening 21a at the main substrate 21 and is fixed to the main substrate 21. As shown in FIG. 2, the main substrate 21 includes four locking portions 21b at which the slot 31 is locked via its locking portions.

In the structure described above, the slot 31, ranging astride the opening 21a both along the lateral direction and the up/down direction in FIG. 2, is fixed onto the main substrate 21, thereby reinforcing the substrate 21, particularly over the area around the opening 21a. Thus, the main substrate 21 does not readily become deformed due to an external force, which, in turn, minimizes the likelihood of camera malfunction. In addition, since the slot 31 for wireless communication is used as a reinforcing member without adding a special reinforcing member, the number of required parts and the production costs can both be minimized.

Next, the wireless communication is described in detail.

As shown in FIG. 1, at the left side of the camera body, a lid 32 for opening/closing the card loading port at the wireless communication slot 31 is disposed, and this lid 32 is supported at the camera body so as to be allowed to rotate around an axis-X. The wireless communication card 50, which includes an internal wireless communication circuit, an antenna 51 disposed at one end thereof and a plurality of electrical contact points disposed at another end thereof, is loaded in the card slot 31, as shown in FIG. 3, with the lid 32 in an open state. A plurality of terminals 33 mounted at the main substrate 21 are inserted within the card loading chamber 31a at the slot 31 so that the electrical contact points at the card 50 come into contact with the terminals 33 when the card 50 is loaded. Thus, the power from a power source at the camera body is supplied to the wireless communication circuit and signal exchange with the control unit on the main substrate 21 is enabled.

As the operation button (transmission button) 25 is pressed down in this state, an ON signal from the operation switch 26 is transmitted to the control unit as described earlier. In response, the control unit sends image data recorded in the internal memory 22 to the wireless communication card 50 via the terminals 33. The wireless communication circuit in the card 50 transmits the image data to an outside recipient via the antenna 51 and thus, the transmitted data are received at the external apparatus. It is to be noted that data other than image data may be transmitted. In addition, information transmitted from an outside source may be received at the antenna 51 and then may be taken into the camera via the wireless communication card 50.

When the wireless communication card 50 is loaded in the slot 31, the antenna 51 projects out from the camera side surface. If the antenna 51 is housed behind the external cover 1 the communication conditions are bound to be poor. The communication conditions will be compromised to a very significant extent if the cover 1 is constituted of a metal, since the metal cover will block electrical waves. Accordingly, the antenna 51 is exposed in the embodiment to assure satisfactory communication conditions at all times, regardless of what material is used to constitute the cover 1. In other words, a metal cover can be used to give the camera high-end appeal.

There is a concern that the wireless communication card 50 may become readily damaged by an external force applied to the antenna 51 projecting out beyond the side surface, e.g., a force applied from the photographer's left hand holding the camera. Accordingly, the lid 32 used to open/close the slot is also utilized as a protective member for protecting the card 50 as described below in the embodiment.

The lid 32 includes an operating knob 32a and a lock plate 32b provided as an integrated part of the knob 32a. In FIG. 1, the lock plate 32b is inserted at a hole 1a formed at the camera body, locking the lid 32 in a closed state. As the knob 32a is slid by a certain extent along direction A in the figure so as to open the lid 32, the lock plate 32b departs the hole 1a, thereby releasing the lock on the lid 32. After opening the lid 32 to the position indicated in FIG. 3, the knob 32a is further slid along direction A so as to insert the lock plate 32 at a hole 1b at the camera body and lock the lid 32 in an open state. The wireless communication card 50 is loaded in this state.

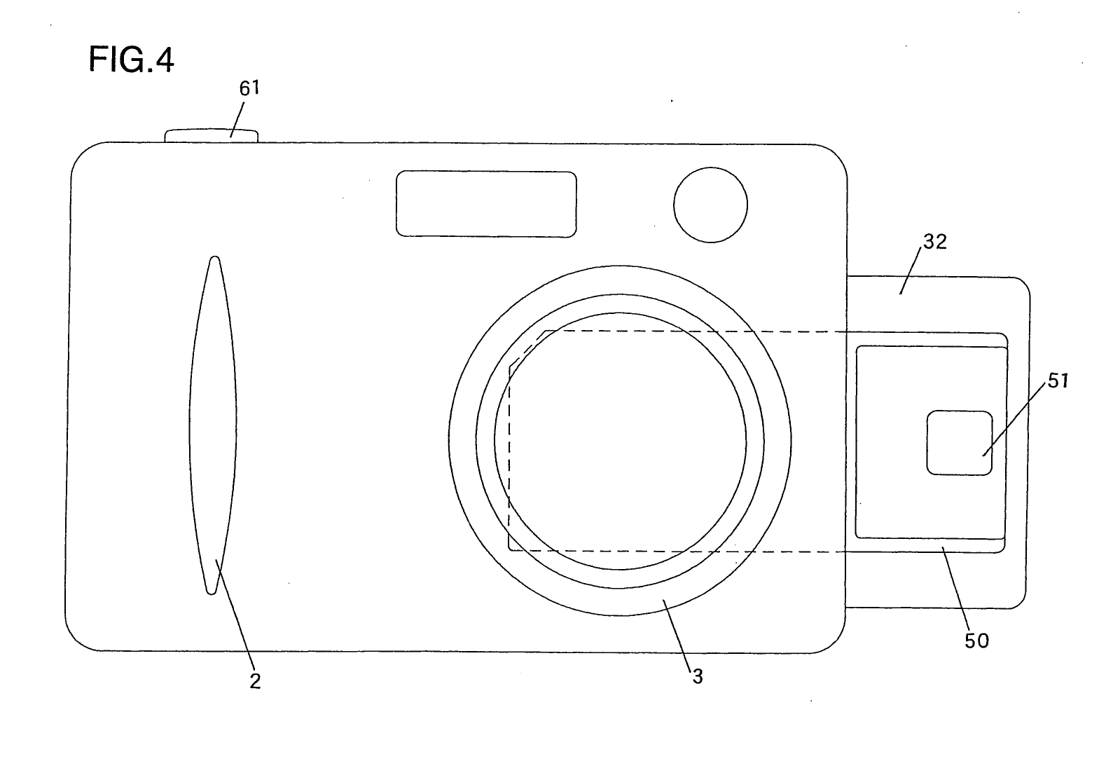

As shown in the front view presented in FIG. 4, the lid 32 locked in the open state covers the projecting portion of the loaded wireless communication card 50 over its entirety from the rear side. Accordingly, the fingers of the photographer's left hand holding the camera are blocked by the lid 32 and do not readily touch the projecting portion of the card 50, lowering the risk of an undesirable force being applied to the card 50. Furthermore, the lid 32 is set immediately behind the projecting portion of the card 50, as shown in FIG. 3. Namely, the gap between the lid 32 and the projecting portion of the card 50 is too narrow for a finger or the like to fit in, thereby providing a further safety measure.

Although the card 50 or the lid 32 projects out from the camera body, they project out along the direction opposite from the direction in which the grip unit 2 is disposed. This means that they do not get in the way when the photographer holds the camera. In addition, since operating members such as a shutter release button 61 (see FIG. 4) and the operation button 25 are disposed at positions easily accessible with a finger of the photographer's right hand holding the grip unit 2, the operability of the camera is not compromised.

It is to be noted that while the wireless communication slot 31 is used as a reinforcing member for reinforcing the main substrate 21 in the explanation provided above, a slot at which a memory card used as an image recording medium is loaded, another card slot or a slot at which a battery is inserted may be used as the reinforcing member. Namely, the reception unit used to reinforce the main substrate 21, into which the electronic unit is detachably loaded may be a memory card slot, a battery loading portion or the like, instead of the wireless communication slot 31. In such a case, a memory card in which image data are recorded or a battery constitutes the electronic unit detachably loaded in the reception unit.

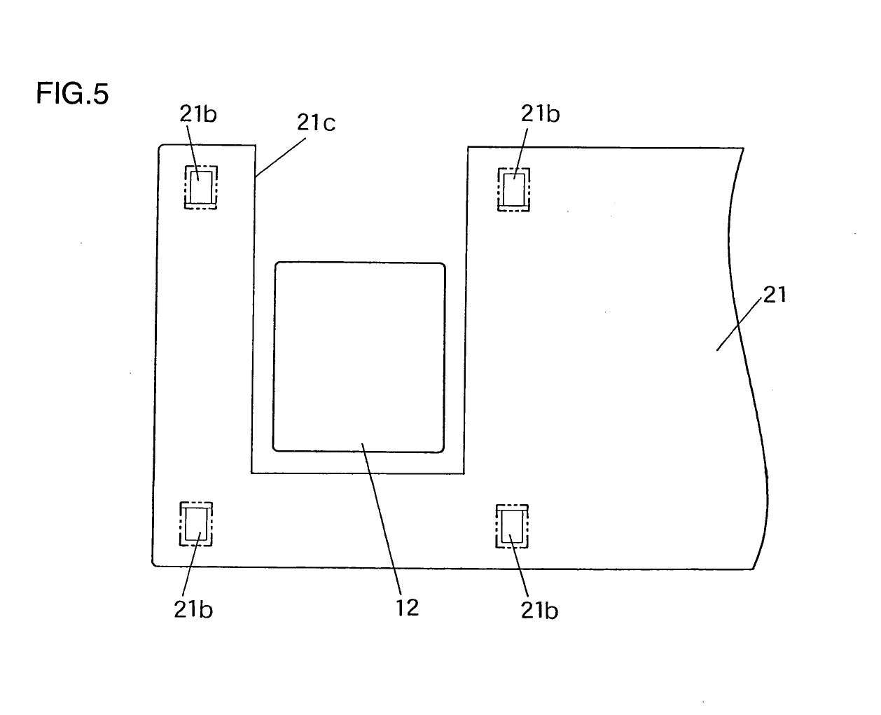

In addition, while the opening 21a of the main substrate 21 at which the imaging substrate 12 is disposed is formed as a substantially quadrangular through hole, as shown in FIG. 2, the shape of the opening at which the imaging substrate 12 is disposed is not limited to this example. For instance, such an opening may be formed as a notch or recess 21c, as shown in FIG. 5. Namely, it should be understood that the opening at the main substrate 21 may be formed as a through hole, as shown in FIG. 2, or as a recess, as shown in FIG. 5.

As described above, in an embodiment of the present invention, the imaging substrate 12 is disposed inside the opening 21a (or the recess 21c) formed at the main substrate 21 so as to set the two substrates 12 and 21 on a substantially single plane rather than layering the two substrates one on top of the other, thereby achieving a lower profile for the camera. In addition, the card slot 31 is made to range astride the opening 21a and its two ends are fixed onto the main substrate 21. Thus, the area around the opening at the main substrate is reinforced without having to add a special reinforcing member to prevent deformation and the like of the main substrate 21.

Furthermore, the antenna 51 of the wireless communication unit 50 loaded in the reception unit 31 is allowed to project out, and thus, good communication conditions are assured. Moreover, the lid member 32 used to open/close the reception unit 31 covers the antenna 51 (projecting portion) of the wireless communication unit 50 so as to protect the projecting portion from external forces in the open state and thus, any damage to the antenna 51 can be prevented without having to add a special protective member.

The above described embodiment is an example only and various modifications can be made without departing from the scope of the invention.

What is claimed is:

1. An electronic camera, comprising:
a sensor substrate at which an imaging element is mounted;
a main substrate on which an electrical component other than the imaging element is mounted, comprising an opening at which the sensor substrate is disposed; and
a reception unit into which an electronic unit is detachably loaded, with the reception unit ranging astride the opening at the main substrate and fixed onto the main substrate so as to reinforce the main substrate.

2. An electronic camera according to claim 1, wherein:.
the main substrate comprises an electrical contact point that makes contact with the electronic unit.

3. An electronic camera according to claim 1, wherein:
the reception unit receives the electronic unit formed in a plate shape.

4. An electronic camera according to claim 1, wherein:
the reception unit receives the electronic unit comprising a wireless communication unit.

5. An electronic camera according to claim 1, wherein:
the reception unit receives the electronic unit comprising a memory card in which image data are recorded.

6. An electronic camera according to claim 1, wherein:
the reception unit receives the electronic unit comprising a battery.

7. An electronic camera according to claim 4, further comprising:
a lid member that opens and closes to cover an entrance to the reception unit, wherein:
part of the wireless communication unit, which includes an antenna, projects out from a casing of the electronic camera when the wireless communication unit is loaded into the reception unit; and
the lid member protects the part of the wireless communication unit that projects out from the casing.

8. An electronic camera according to claim 7, wherein:
the part of the wireless communication unit projects out from a side surface of the casing; and
the lid member covers an entire front surface or an entire rear surface of the antenna that projects out.

9. An electronic camera according to claim 8, further comprising:
a grip unit disposed near a side surface present on a side opposite from the side surface from which the part of the wireless communication unit projects.

10. An electronic camera, comprising:
a reception unit at which a wireless communication unit is detachably loaded;
a casing in which the reception unit is housed;
an antenna that projects out of the casing when the wireless-communication unit is loaded in reception unit; and
a lid member that opens and closes to cover an entrance to the reception unit and protects part of the wireless communications unit projecting out of the casing, which includes the antenna.

11. An electronic camera according to claim 10, wherein:
the casing is a casing of the electronic camera;
the part of the wireless communication unit projects out from a side surface of the casing of the electronic camera; and
the lid member covers an entire front surface or an entire rear surface of the part of the wireless communication unit that projects out.

12. An electronic camera according to claim 11, further comprising:
a grip unit disposed near a side surface present on a side opposite from the side surface from which the part of the wireless communication unit projects.

13. An electronic camera according to claim 7, wherein:
the lid member opens or closes as the lid member rotates around an axis extending along a longer side of the entrance to the reception unit.

14. An electronic camera according to claim 13, wherein:
the lid member enters an open state by rotating around the axis to protect the part of the wireless communication unit that projects out.

15. An electronic camera according to claim 14, further comprising:
a close lock member that locks the lid member in a closed state; and
an open lock member that locks the lid member in the open state.
